(19) United States
(12) Patent Application Publication
(10) Pub. No.: US 2021/0197299 A1
(43) Pub. Date: Jul. 1, 2021

(54) TABLE SAW HAVING ROLLERS AT DIFFERENT ELEVATIONS

(71) Applicant: Chin-Chin Chang, Taichung City (TW)

(72) Inventor: Chin-Chin Chang, Taichung City (TW)

(21) Appl. No.: 16/726,894

(22) Filed: Dec. 25, 2019

(51) Int. Cl. B23D 47/02; B23D 47/04; B23D 45/06; B23D 59/00

(52) U.S. Cl. CPC B23D 47/025; B23D 59/001; B23D 45/06; B23D 47/04

(57) ABSTRACT

A table saw includes a base assembly; a table assembly mounted on the base assembly and comprising a table and a circular saw blade; a rip fence assembly moveably disposed on one end of the table assembly; and a slide mechanism mounted on the table assembly and including front and rear tracks affixed to front end rear ends of the table respectively; front and rear slides each having one end secured to either end of the rip fence assembly and the other end being open wherein the front and rear slides are moveably mounted on the front and rear tracks respectively; and first, second, third, fourth, and fifth rollers disposed in each of the front and rear tracks. The first, second, fourth, and fifth rollers are at an elevation higher than that of the third roller.

### BACKGROUND OF THE INVENTION

### 1. Field of the Invention

The invention relates to table saws and more particularly to a table saw having first, second, third, fourth and fifth rollers in each of front and rear tracks affixed to a table assembly in which the first, second, fourth and fifth rollers are at an elevation higher than that of the third roller so that two slides, attached to a rip fence, moving along the front and rear tracks respectively can be slidably supported by the first and second rollers in one moving direction and slidably supported by the fourth and fifth rollers in the other opposite moving direction.

### 2. Description of Related Art

U.S. Pat. No. 10,183,415 to Chang, entitled “table saw”, discloses a table saw comprising a table, a saw, a track, a slide strip, and a fence member. The table has an axial direction and a radial direction which are orthogonal to each other. The saw is arranged at a predetermined position of the table. The track is arranged at each side of the table. The slide strip is slidably engaged with the track. An outer surface of the slide strip opposite to the track has a first position part, a second position part, and a third position part. The first position part and the second position part are respectively arranged at two ends of the slide strip and the third position part is arranged at a center of the slide strip. The fence member is bridged on the table and secured to one of the first position part, the second position part, and the third position part.

Moreover, in the '415 patent in cutting the workpiece the slide strips may be displaced due to weight of the workpiece. And in turn, the tracks may be downward displaced. Thus, operations of the slide strips and the tracks are not smooth. Further, excessive wear may be occurred between the slide strips and the tracks due to great friction. As a result, an appropriate fit between the slide strips and the tracks is compromised. In short, there is no balance device provided for the slide strip in response to the weight of the workpiece.

Thus, the need for improvement still exists.

### SUMMARY OF THE INVENTION

It is therefore one object of the invention to dispose a table saw comprising a base assembly; a table assembly mounted on the base assembly and comprising a table and a circular saw blade; a rip fence assembly moveably disposed on one end of the table assembly; and a slide mechanism mounted on the table assembly and comprising front and rear tracks affixed to front end rear ends of the table respectively; front and rear slides each having one end secured to either end of the rip fence assembly and the other end being open wherein the front and rear slides are moveably mounted on the front and rear tracks respectively; and first, second, third, fourth, and fifth rollers disposed in each of the front and rear tracks; wherein the first, second, fourth, and fifth rollers are at an elevation higher than that of the third roller; wherein in a first movement toward a first direction top of each of the front and rear slides is supported by the first and second rollers, and bottom thereof is supported by the third roller; and wherein in a second movement toward a second direction which is opposite to the first direction, the top of each of the front and rear slides is supported by the third and fourth rollers, and the bottom thereof is supported by the third roller.

The above and other objects, features and advantages of the invention will become apparent from the following detailed description taken with the accompanying drawings.

### BRIEF DESCRIPTION OF THE DRAWINGS

FIG. 1 is a perspective view of a table saw according to the invention;

FIG. 2 is an exploded, perspective view of the table saw;

FIG. 3 is a side elevation of FIG. 2;

FIG. 4 is a detailed view of the area in a rectangle A of FIG. 3;

FIG. 5 is a top view of the table saw with the rip fence removed;

FIG. 6 is a sectional view taken along line VI-VI of FIG. 5;

FIG. 7A is a detailed view of the area in a rectangle B of FIG. 6;

FIG. 7B is a detailed view of the area in a rectangle C of FIG. 6;

FIG. 8 is a side elevation view of the table saw with the slides moving rightward;

FIG. 9 is a detailed view of the area in a rectangle D of FIG. 8;

FIG. 10 is a side elevation view of the table saw with the slides moving leftward; and

FIG. 11 is a detailed view of the area in a rectangle E of FIG. 10.

### DETAILED DESCRIPTION OF THE INVENTION

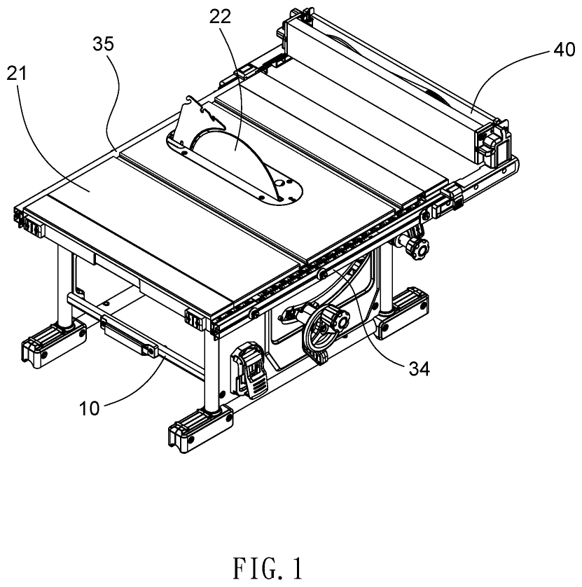

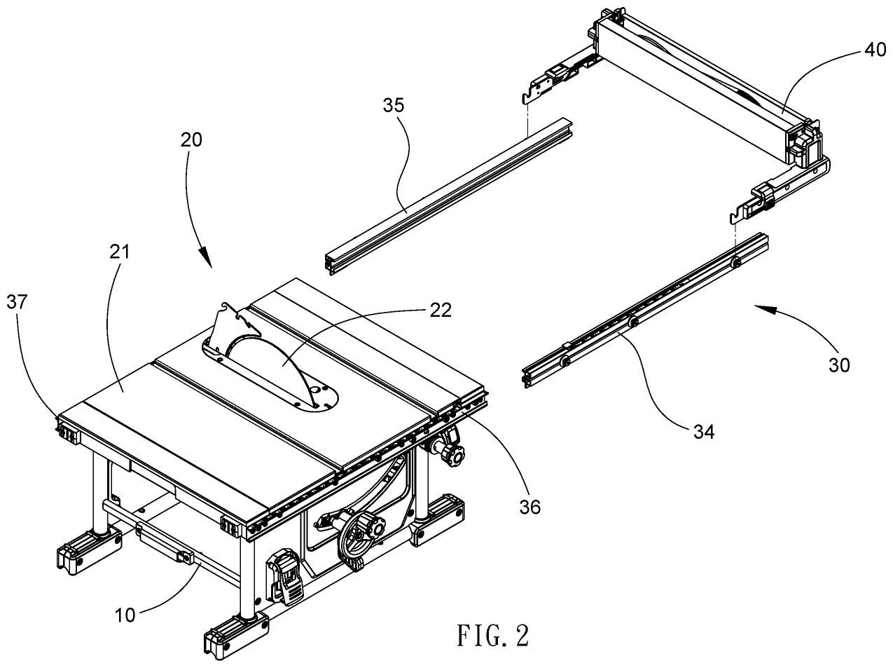

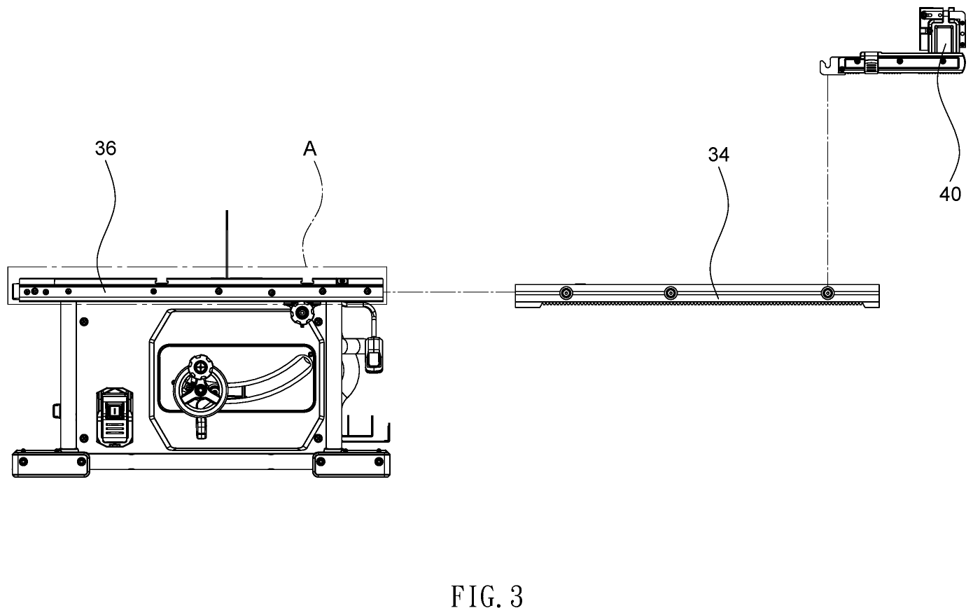

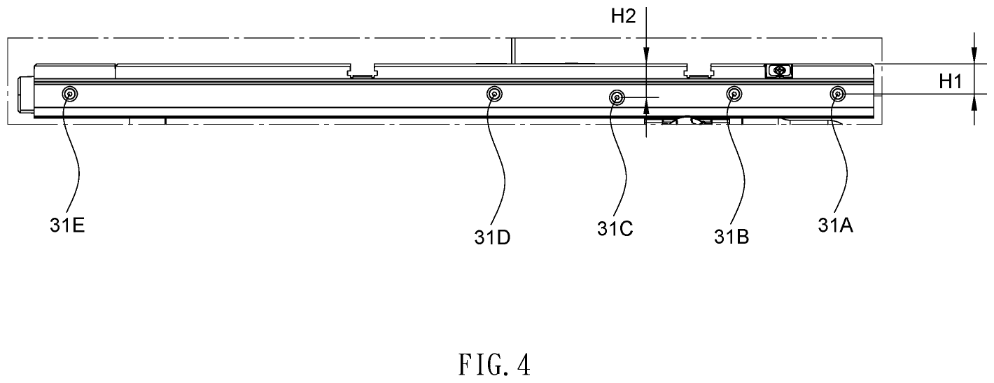

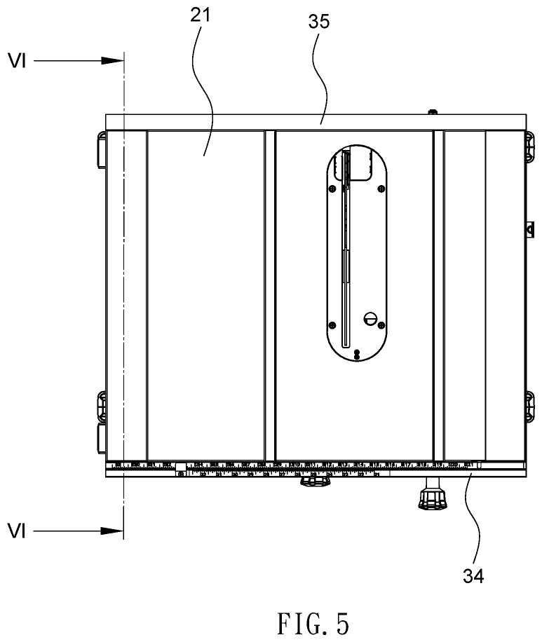

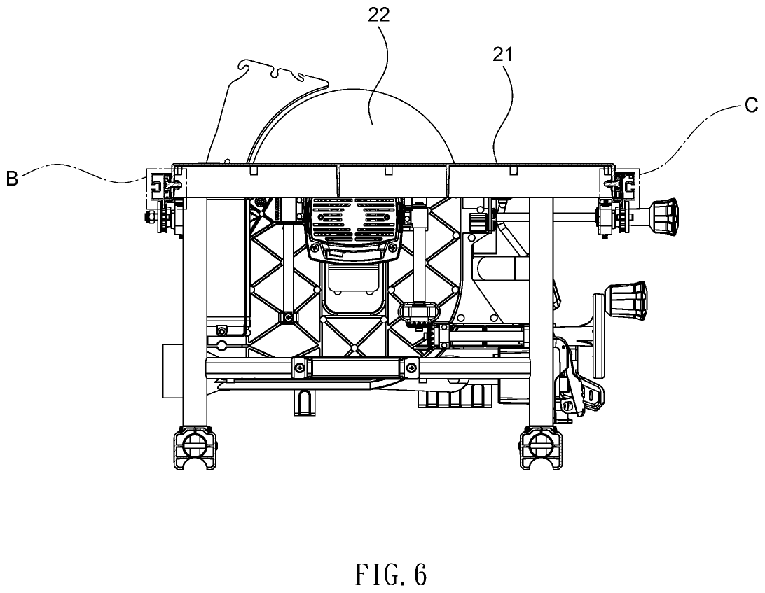

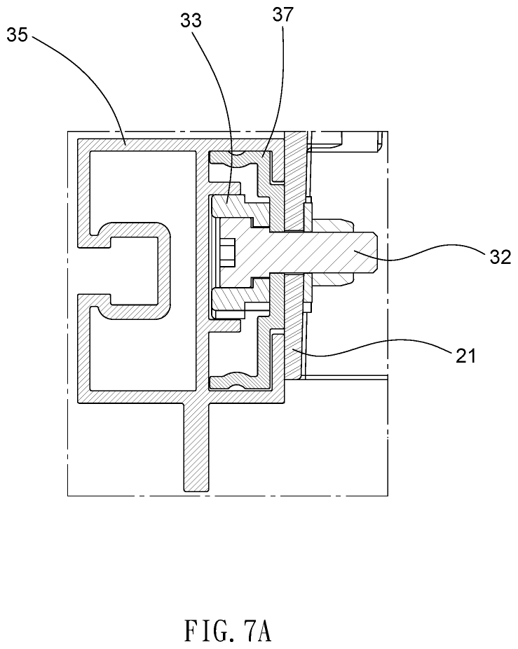

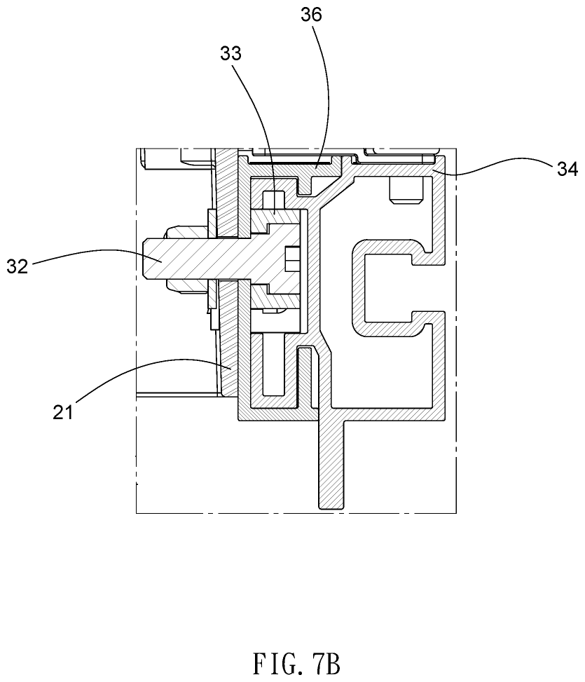

Referring to FIGS. 1 to 11, a table saw in accordance with the invention comprises a base assembly 10, a table assembly 20 mounted on the base assembly 10 and including a table 21 and a circular saw blade 22, a slide mechanism 30 mounted on the table assembly 20, and a rip fence assembly 40 moveably disposed on the right side of the table assembly 20.

The slide mechanism 30 as the subject of the Invention is discussed in detail below.

First, second, third, fourth and fifth rollers 31A, 31B, 31C, 31D and 31E are provided in each of front and rear tracks 36, 37 which are affixed to front and rear ends of the table 21 respectively. The first, second, fourth and fifth rollers 31A, 31B, 31D and 31E are at an elevation higher than that of the third roller 31C as illustrated by height H2 being greater than height H1. Each of the first, second, third, fourth and fifth rollers 31A, 31B, 31C, 31D and 31E includes a bolt and nut combination 32 secured to both the front track 36 (or the rear track 37) and the table assembly 20, and a rotation member 33 rotatably mounted on the head of the bolt nut combination 32. Each of front slide 34 and rear slide 35 has one end secured to either end of the rip fence assembly 40 and the other end being open. The front and rear slides 34, 35 are moveably mounted on the front and rear tracks 36, 37 respectively.

The front track 36 and the front slide 34 are taken as an exemplary example in the following discussion.

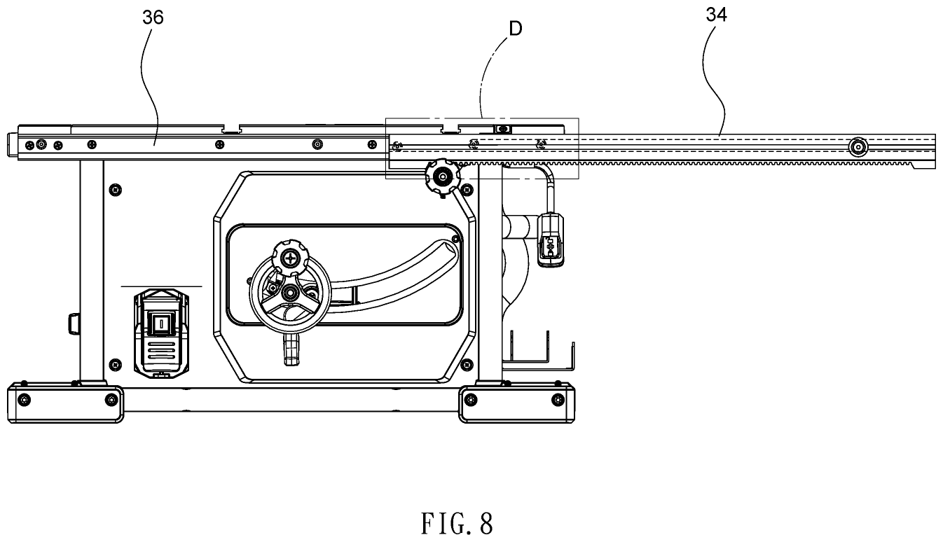

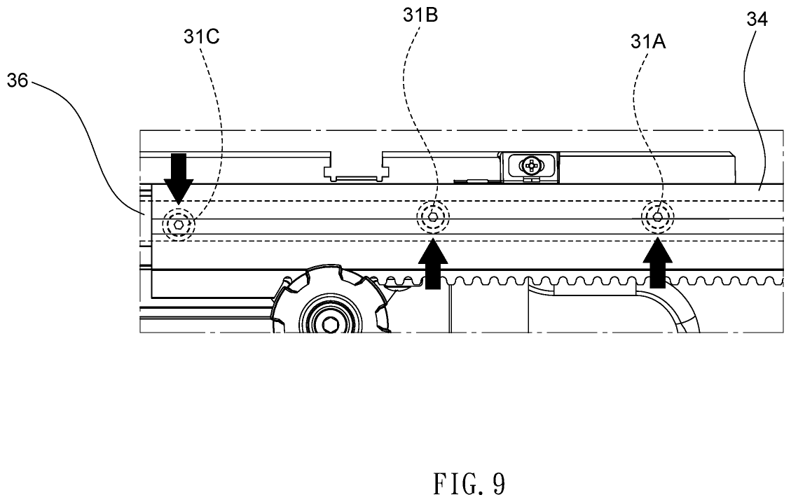

Top of the front slide 34 moving along the front track 36 is slidably supported by the first and second rollers 31A, 31B, and bottom of the front slide 34 moving along the front track 36 is slidably supported by the third roller 31C when the front slide 34 moves in the right direction (see FIGS. 8 and 9). Thus, it is possible of withstanding weights of the workpiece, the front slide 34 and the rear slide 35 in addition to providing a balance for compensating undesired displacements.

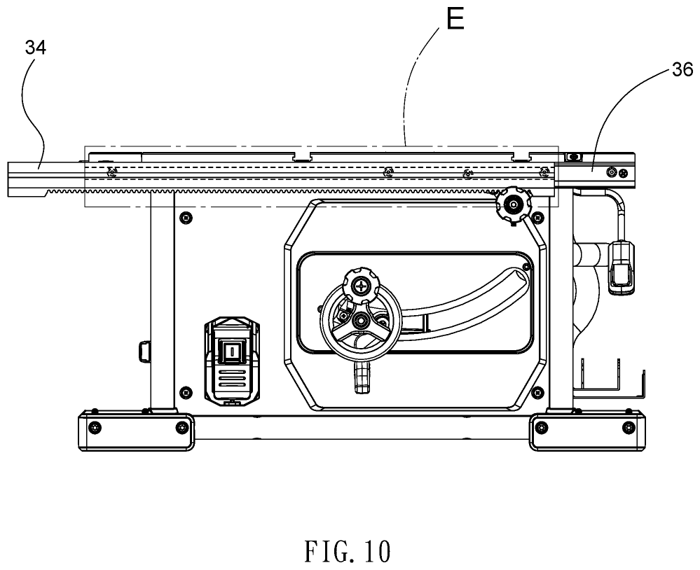

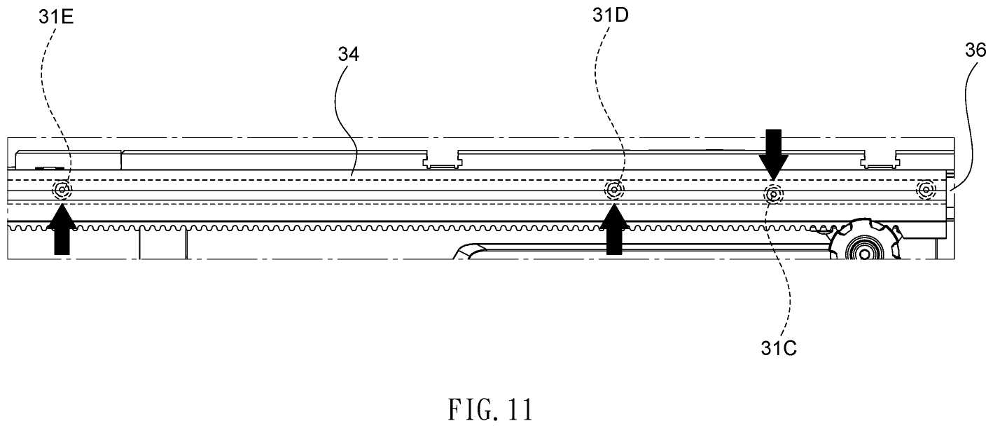

Likewise, the top of the front slide 34 moving along the front track 36 is slidably supported by the fourth and fifth rollers 31D, 31E, and the bottom of the front slide 34 moving along the front track 36 is slidably supported by the third roller 31C when the front slide 34 moves in the left direction (see FIGS. 10 and 11). Thus, it is possible of withstanding weights of the workpiece, the front slide 34 and the rear slide 35 in addition to providing a balance for compensating undesired displacements.

In brief, as a balance, the bottom of the third roller 31C supports the front slide 34 from above and the tops of the first, second, fourth and fifth rollers 31A, 31B, 31D and 31E support the front slide 34 from below.

Similarly, as a balance, the bottom of the third roller 31C supports the rear slide 35 from above and the tops of the first, second, fourth and fifth rollers 31A, 31B, 31D and 31E support the rear slide 35 from below.

It is envisaged by the invention that the sliding movements of the front and rear slides 34, 35 is much stable due to the balance effect of the elevations of the first, second, fourth and fifth rollers 31A, 31B, 31D and 31E different from that of the third roller 31C.

While the invention has been described in terms of preferred embodiments, those skilled in the art will recognize that the invention can be practiced with modifications within the spirit and scope of the appended claims.

1-2. (canceled)

3. A table saw, comprising:
a base assembly;
a table assembly mounted on the base assembly and comprising a table and a circular saw blade;
a rip fence assembly moveably disposed on one end of the table assembly; and
a slide mechanism mounted on the table assembly and comprising front and rear tracks affixed to front and rear ends of the table respectively; front and rear slides each having one end secured to either end of the rip fence assembly and the other end being open wherein the front and rear slides are moveably mounted on the front and rear tracks respectively; and first, second, third, fourth and fifth rollers disposed in each of the front and rear tracks;
wherein the first, second, fourth and fifth rollers are at an elevation higher than that of the third roller;
wherein each of the first, second, third, fourth and fifth rollers includes a bolt and nut combination secured to both the table assembly and one of the front and rear tracks, and a rotation member rotatably mounted on the head of the bolt nut combination;
wherein in a first movement toward a first direction, the top of each of the front and rear slides is supported by the first and second rollers, and the bottom thereof is supported by the third roller; and
wherein in a second movement toward a second direction which is opposite to the first direction, the top of each of the front and rear slides is supported by the fourth and fifth rollers, and the bottom thereof is supported by the third roller.
